(19) United States
(12) Patent Application Publication
(10) Pub. No.: US 2010/0100493 A1
(43) Pub. Date: Apr. 22, 2010

(54) METHOD AND APPARATUS FOR PROVIDING SOCIAL HEALTH TRACKING

(76) Inventors: L. Russell Canfield, Santa Fe, NM (US); Christopher Volinsky, Morristown, NJ (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/252,854

(22) Filed: Oct. 16, 2008

(51) Int. Cl. G06Q 99/00

(52) U.S. Cl. 705/319

(57) ABSTRACT

A method and apparatus for providing social health tracking over one or more communication networks are disclosed. For example, the method receives a request from a customer for a communication service having a social health tracking feature, and gathers data on one or more interactions for the customer. The method updates a statistical model for the one or more interactions for the customer over a period of time, and determines a social health status for the customer from the statistical model.

The present invention relates generally to communication networks and, more particularly, to a method and apparatus for providing social health tracking over one or more communication networks such as Internet Protocol (IP) networks, wireless networks, and the like.

### BACKGROUND OF THE INVENTION

Today's communication networks enable users to communicate using a variety of communication media. For example, users may exchange voice and data packets using a cell phone, a land-line phone, text messaging devices, computers, and so on. The communication among various users and the type of communication among various users may change over time. For example, two users may generally communicate via emails, but during a significant event the two users may communicate over a cell phone instead. For example, friends and family who may be exchanging emails once a week may increase their communication or change the type of communication when planning for a visit or a joint family trip.

In another example, researchers have reported isolation as a risk factor for certain health conditions and/or recovery from certain health conditions. For example, people who attend support groups while recovering from illnesses tend to recover in a shorter period of time when compared to people who do not attend such support groups. Thus, the degree of connectedness with others may be a component of ones social health.

### SUMMARY OF THE INVENTION

In one embodiment, the present invention discloses a method and apparatus for providing social health tracking over one or more communication networks. For example, the method receives a request from a customer for a communication service having a social health tracking feature, and gathers data on one or more interactions for the customer. The method updates a statistical model for the one or more interactions for the customer over a period of time, and determines a social health status for the customer from the statistical model.

### BRIEF DESCRIPTION OF THE DRAWINGS

The teaching of the present invention can be readily understood by considering the following detailed description in conjunction with the accompanying drawings, in which:

FIG. 1 is a block diagram depicting an exemplary network related to the current invention;

FIG. 2 illustrates an exemplary network with social health tracking;

FIG. 3 illustrates a flowchart of a method for social health tracking; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing social health tracking over one or more communication networks such as Internet Protocol (IP) networks, wireless networks, and the like. Although the present invention is discussed below in the context of IP networks, the present invention is not so limited. Namely, the present invention can be applied for any network wherein voice and data packets may be sent and received, e.g., cellular networks, traditional telephone networks, and the like.

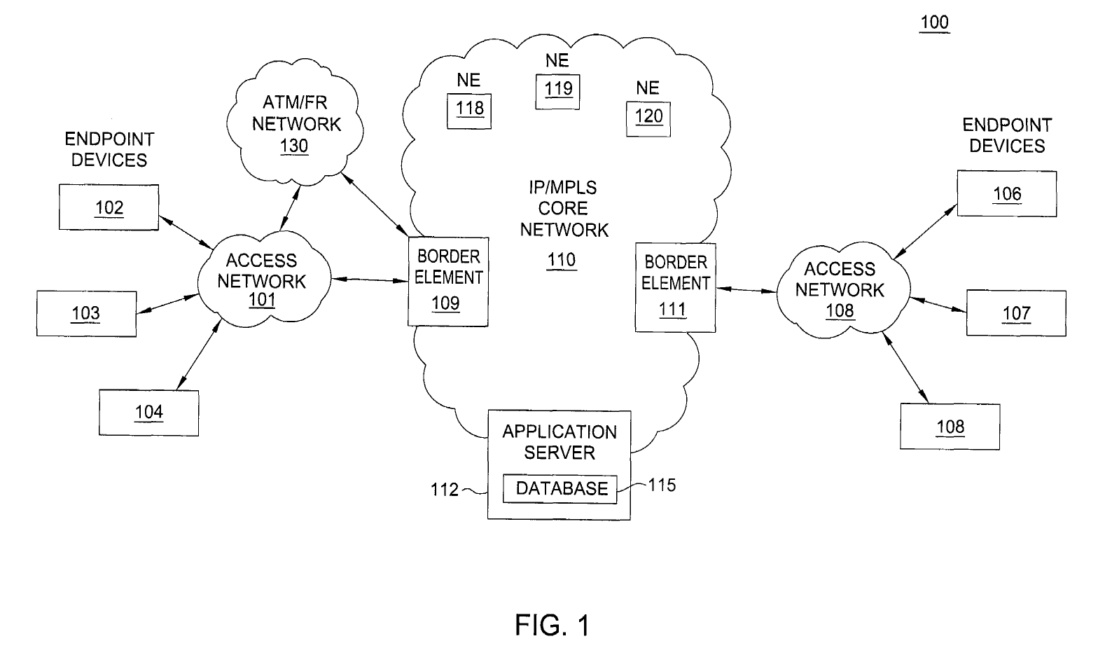

FIG. 1 is a block diagram depicting an exemplary network 100 related to the current invention. Exemplary networks include switched networks, Internet protocol (IP) networks, Asynchronous Transfer Mode (ATM) networks, frame-relay networks, wireless networks, and the like.

A switched network is broadly defined as a network that creates continuous pathways between callers and called parties by disconnecting and reconnecting lines in various configurations (i.e. by switching). ATM, frame-relay and IP networks, etc. are packet based networks. An IP network is broadly defined as a network that uses Internet Protocol such as IPv4, IPv6 and the like to exchange data packets. Wireless networks are networks used to enable users to communicate using wireless devices, e.g. Global System for Mobile (GSM) networks, wide area cellular telephone networks like 2G and 3G (second and third generation cellular networks), etc.

In one embodiment, the network 100 may comprise a plurality of endpoint devices 102-104 configured for communication with the core packet network 110 (e.g., an IP based core backbone network supported by a service provider). The endpoint devices 102-104 may communicate with the IP/MPLS core network 110 via an access network 101. Similarly, a plurality of endpoint devices 105-107 are configured for communication with the core packet network 110 via an access network 108. The network elements 109 and 111 may serve as gateway servers or edge routers (broadly referred to as border elements) for the IP/MPLS core network 110.

The endpoint devices 102-107 may comprise customer endpoint devices such as personal computers, laptop computers, Personal Digital Assistants (PDAs), servers, routers, and the like. The access networks 101 and 108 serve as a means to establish a connection between the endpoint devices 102-107 and one or more of the NEs 109 and 111. The access networks 101 and 108 may each comprise a Digital Subscriber Line (DSL) network, a broadband cable access network, a Local Area Network (LAN), a Wireless Access Network (WAN), a 3^{rd} party network, and the like.

The access networks 101 and 108 may be either directly connected to NEs 109 and 111 of the IP/MPLS core network 110 or through an Asynchronous Transfer Mode (ATM) and/or Frame Relay (FR) switch network 130. If the connection to the IP/MPLS core network 110 is through the ATM/FR network 130, the packets from customer endpoint devices 102-104 (traveling towards the IP/MPLS core network 110) traverse the access network 101 and the ATM/FR switch network 130 and reach the border element 109.

The ATM/FR network 130 contains Layer 2 switches functioning as Provider Edge Routers (PER) and/or Provider Routers (PR). The PERs may also contain an additional Route Processing Module (RPM) that converts Layer 2 frames to Layer 3 Internet Protocol (IP) frames. An RPM enables the transfer of packets from a Layer 2 Permanent Virtual Connection (PVC) circuit to an IP network which is connectionless.

Some NEs (e.g., NEs 109 and 111) reside at the edge of the IP/MPLS core infrastructure and interface with customer endpoints over various types of access networks. An NE that resides at the edge of a core infrastructure is typically implemented as an edge router, a media gateway, a border element, a firewall, a switch, and the like. An NE may also reside within the IP network (e.g., NEs 118-120) and may be used as a mail server, honeypot, a router, or like device. The IP/MPLS core network 110 also comprises an application server 112 that contains a database 115. The application server 112 may comprise any server or computer that is well known in the art, and the database 115 may be any type of electronic collection of data that is also well known in the art. Those skilled in the art will realize that although only six endpoint devices, two access networks, five border elements, one application server, and so on are depicted in FIG. 1, the communication system 100 may be expanded by including additional endpoint devices, access networks, network elements, application servers, 3^{rd} party networks, etc. without altering the scope of the present invention.

The above IP network is described to provide an illustrative environment in which packets for voice and data services are transmitted on networks. The current invention discloses a method and apparatus for providing social health tracking over one or more communications networks.

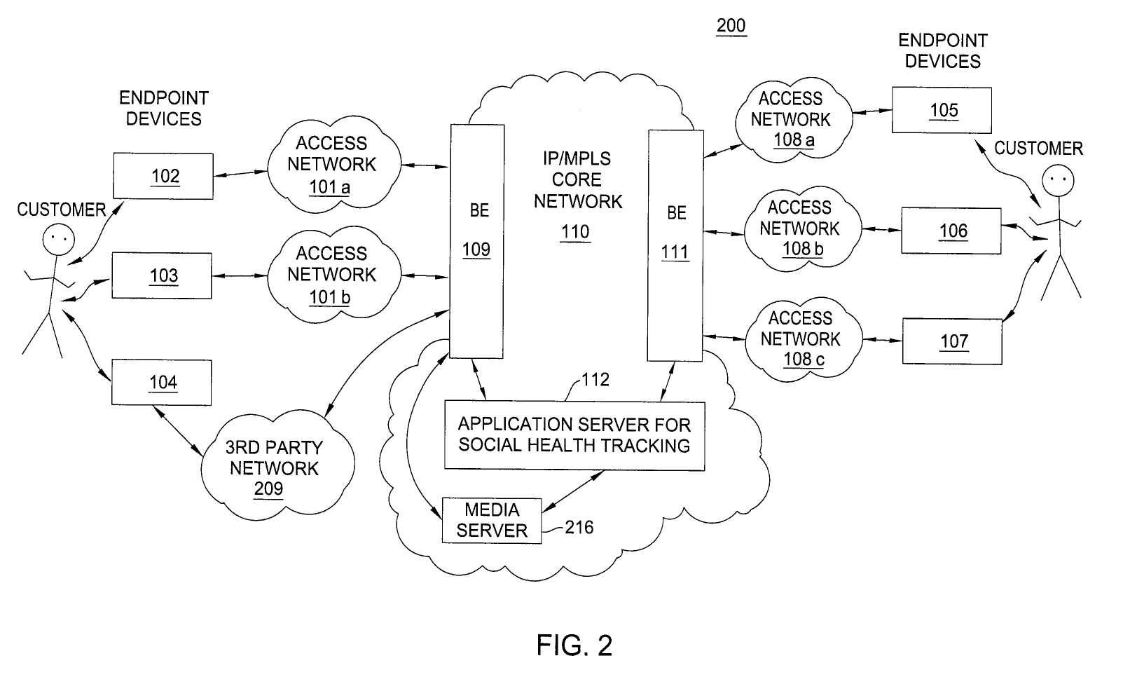

FIG. 2 illustrates an exemplary network 200 with social health tracking. For example, a customer with user endpoint devices 102, 103 and 104 is communicating with another customer with user endpoint devices 105, 106 and 107 over an IP/MPLS core network 110. The IP/MPLS core network 110 contains the Border Elements (BE) 109 and 111. The user endpoint devices 102 and 103 are connected to the IP/MPLS core network 110 via an access network 101a or 101b, and BE 109. The user endpoint device 104 is connected to the IP/MPLS core network 110 via a 3^{rd} party network 209 and BE 109. Similarly, user endpoint devices 105, 106 and 107 are connected to the IP/MPLS core network 110 via an access network 108a, 108b or 108c, and 8E 111. In one embodiment, the IP/MPLS core network 110 also contains an application server for social health tracking 112 and a media server 216.

In one embodiment, the service provider has implemented the current invention for social health tracking in an application server 112. The method first receives a request for a service with social health tracking from a customer. For example, a customer may subscribe to a Voice over Internet Protocol (VoIP) service, a cellular service, etc. along with a social health tracking feature.

In another example, the network service provider may provide one or more networking services to the customer with an option to have his/her social health tracked.

The method then gathers data on interactions for the customer. For example, the customer may have requested the service provider to perform social health tracking by gathering data from cell phone usage, land-line telephone usage, emails, online chat room usage, online game playing, Short Message Service (SMS), Instant Messaging (IM), and the like. In one embodiment, the method gathers data on interactions from Call Detail Records (CDRs). Call detail record refers to a record containing information relating to a single call or session. For example, a CDR may contain origination and destination addresses for a call, duration of a call, disposition of a call such as whether or not the call was successful, network information that may be used for billing such as one or more carrier identifications, etc.

In one embodiment, the method builds a statistical model for one or more interactions for the customer. For example, the method may create a statistical model for tracking interaction of the customer with each destination. For example, the method may track frequency of communication, means of communication, duration of communication, and the like for each customer on a per destination address basis. In one embodiment, the statistical model can be a regression or classification model which could be trained on data from a trial study and may incorporate knowledge from the medical field about social health. It should be noted that the present invention is not limited to a particular type of statistical model.

In one embodiment, the method tracks the statistics for the one or more interactions over a predetermined period of time, e.g., a month, 6 months, a year and so on. For example, the method may track the frequency of communication, means of communication, duration of communication, and the like with the customer's friends, family, and so on over a period of time such as a day, a week, a month, a year, several years, and so on.

The method may then determine a social health status for the customer from the statistics. For example, the method may determine that the customer has reduced interactions with one or more specific destinations by 50%. For example, a customer may not have communicated with family members in the latest period of time (e.g., the last month) as often as he/she did in previous periods of time (e.g., previous months).

In turn, the method is able to provide the determined social health status to the customer. For example, the method may provide a social health status to the customer in a form of a score, a category, a graph, and the like. For example, the method may notify the customer that his/her social health as being below a normal level when the customer has less interactions based on historical records.

In one embodiment, the method presents the social health status in terms of one or more of: a numerical score, a graphical chart, or a categorical chart. For example, a numerical score may be established by tracking long term averages and changes (e.g., on 1-100 scale and the like). For example, if a customer is communicating with a particular destination at a reduced frequency, e.g., 50% less when compared to historical data, then a numerical score of “50” can be presented to the customer. It should be noted that averaging, normalization and like functions can be applied before a numerical score is presented to the customer.

In another example, a graphical chart, e.g., a bar graph, can be used for ease in visualizing the social health across multiple destinations. For example, each bar in the bar graph may represent a destination address. The bar chart may incorporate color, e.g., a green bar represents a healthy social health status, a yellow bar may represents a social health status that needs improvement, and a red bar may represent an unhealthy social health status, and so on.

In yet another example, a categorical chart may simply present the social health status in broad terms. For example, the categorical chart may simply display a plurality of destinations and provide next to each destination a categorical term such as: “healthy”, “unhealthy”, “need improvement”, and the like.

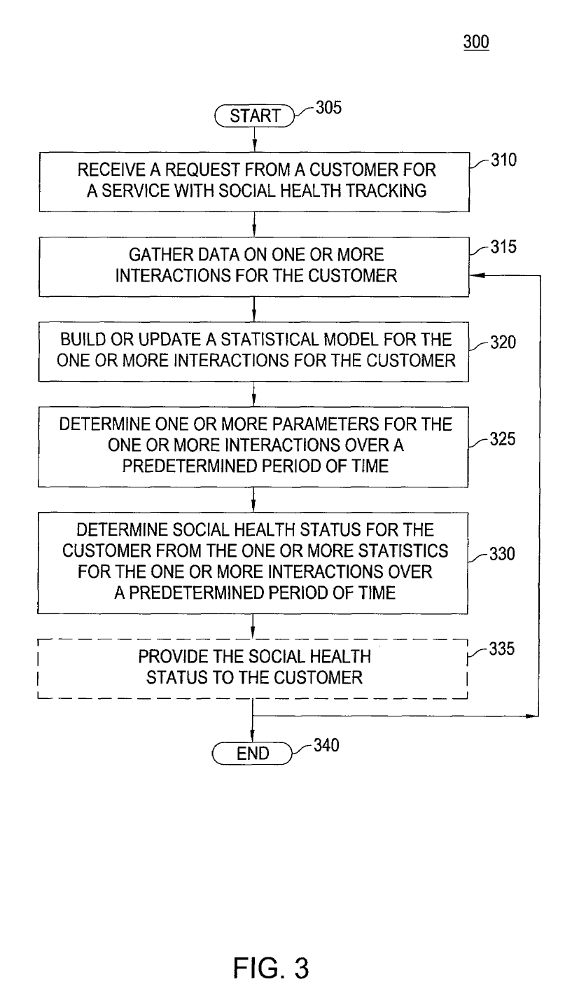

FIG. 3 illustrates a flowchart of a method 300 for providing social health tracking. For example, one or more steps of method 300 can be implemented in application server 112. Method 300 starts in step 305 and proceeds to step 310.

In step 310, method 300 receives a request from a customer for a communication service with a social health tracking feature. For example, a customer may subscribe to a VoIP service with a social health tracking feature.

In another example, the network service provider may provide one or more networking services to the customer and provide an option to the customer to have his/her social health tracked. For example, the social health tracking may be an opt-in (or opt-out) feature available to customers.

In step 315, method 300 gathers data on one or more interactions for the customer. For example, the customer may have requested the service provider to perform social health tracking by gathering data from Call Detail Records (CDRs) related to interactions on one or more type of communications comprising of: cell phone communication, land-line telephone communication, email communication, online chat room communication, online game playing, Short Message Service (SMS) communication, Instant Messaging (IM) communication, and the like. The method then gathers CDRs for interactions in accordance with the customer request.

In step 320, method 300 builds or updates a statistical model for the one or more interactions for the customer. For example, the method may create a statistical model for tracking interactions with each destination communicated with by the customer. For example, the method may track frequency of communication, means of communication, duration of communication, etc. for each destination address interacting with the customer.

In step 325, method 300 determines or selects one or more parameters or statistics for the one or more interactions to be tracked over a predetermined period of time, e.g., each day, each week, each month, each quarter, every 6 months, each year, and so on. For example, the method may track the frequency of communication, means of communication, duration of communication, and the like with the customer's friends, family, etc.

In step 330, method 300 determines a social health status for the customer using the statistical model in accordance with one or more parameters for the one or more interactions over a predetermined period of time. For example, the method may determine that the customer has reduced the frequency of interactions with family members by 50%. The method then proceeds to optional step 335 to provide social health status to the customer.

In optional step 335, method 300 provides the social health status to the customer. For example, the method may provide the social health status to the customer (e.g., a “push” mode of forwarding the social health status to the user) in a form of a score, a chart, a category, and the like. For the example above, the method may notify (e.g., via an email, an SMS, in a monthly bill and the like) the customer that his/her social health as being below normal level when the customer has less interactions with family members. Alternatively, the customer may interact with an on-line server (e.g., a “pull” mode of presenting the social health status to the user only as requested by the user) that will display the social health status when the customer accesses his or her account. In one embodiment, the particular mode of delivery or the medium in which the social health status is delivered to the user can be implemented via a user defined profile. In other words, the user can specify a preference as to the particular mode of delivery and/or the medium in which the social health status will be delivered to the user. The method then ends in step 340 or returns to step 315 to continue gathering data.

In one embodiment, the service provider receives specific authorization for performing social health tracking from the customer for one or more types of communications. For example, the customer may authorize the service provider to track emails, and text message interactions, but does not authorize the tracking of cell phone communications.

In one embodiment, the authorization for performing social health tracking received from a customer is based on the type of user endpoint device. For example, the customer may authorize the service provider to perform social health tracking based on interactions over a computer connected to the Internet while not allowing tracking of interactions over a cell phone.

In one embodiment, the method also gathers data on interactions for the customer from 3^{rd} party network service providers. For example, a customer may use another service provider for one mode of communication. For example, the customer may have a different service provider for his/her cell phone and may wish the social health tracking to be performed by his/her IP service provider. The customer may then authorize the IP service provider to gather data on his/her cell phone interaction from the cellular phone service provider.

In one embodiment, the method receives inputs from the customer to determine what constitutes a healthy condition versus an unhealthy condition as related to the customer's social health. For example, a customer may be satisfied with one or two emails a day, while another customer may consider receiving less that 30 emails a day as being socially isolated. For example, the user may provide customer feedback to the service provider as to how to interpret an alert that was generated by the service provider. For example, a service provider may provide an alert to the user indicating that it was detected there was a significant change in interaction with a particular individual or a group of individuals. The service provider may ask the user to provide feedback, e.g., “Is the change in interaction due to a one time event (e.g., user on vacation, user on business trip), or “Is the change in interaction not due to a one time event”, and so on.

In one embodiment, the inputs received from the customer pertain to the type of destinations. For example, a customer may consider interactions with a specific IP address, person, family, groups of friends, to be relevant indications of social health of the customer, while considering interactions with other people, e.g., coworkers, etc., as being unrelated to social health. For example, the customer may have changed jobs or moved to a different organization within the same company, thereby resulting in establishing new relationships with different coworkers and new communication patterns that will show a significant change.

In one embodiment, the service provider configures the period of time for tracking statistical changes for the one or more interactions. For example, one service provider may track statistical changes over a 3 month period while another service provider tracks over a year. However, in one embodiment, the predefined period of time can be selected by the customer.

Those skilled in the art would realize that the current invention for social health tracking may be implemented at a customer location, at an access provider's location, at the network service provider's location, or at a 3^{rd} party location.

It should be noted that although not specifically specified, one or more steps of method 300 may include a storing, displaying and/or outputting step as required for a particular application. In other words, any data, records, fields, and/or intermediate results discussed in the method 300 can be stored, displayed and/or outputted to another device as required for a particular application. Furthermore, steps or blocks in FIG. 3 that recite a determining operation, or involve a decision, do not necessarily require that both branches of the determining operation be practiced. In other words, one of the branches of the determining operation can be deemed as an optional step.

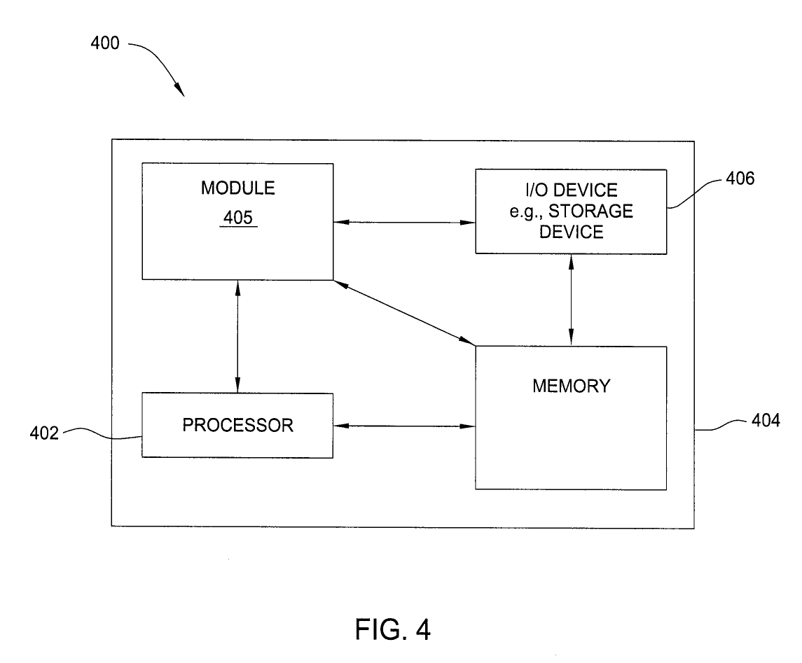

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing social health tracking, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, alarm interfaces, power relays and the like)).

It should be noted that the present invention can be implemented in software and/or in a combination of software and hardware, e.g., using application specific integrated circuits (ASIC), a general-purpose computer or any other hardware equivalents. In one embodiment, the present module or process 405 for providing social health tracking can be loaded into memory 404 and executed by processor 402 to implement the functions as discussed above. As such, the present method 405 for providing social health tracking (including associated data structures) of the present invention can be stored on a computer readable medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing social health tracking, comprising:
receiving a request from a customer for a communication service having a social health tracking feature;
gathering data on one or more interactions for said customer;
updating a statistical model for said one or more interactions for said customer over a period of time; and
determining a social health status for said customer from said statistical model.

2. The method of claim 1, wherein said statistical model tracks one or more parameters comprising at least one of: a frequency of communication, a type of communication, or a duration of communication.

3. The method of claim 1, further comprising:
providing said social health status to said customer.

4. The method of claim 1, wherein an authorization for performing said social health tracking feature is received from said customer.

5. The method of claim 4, wherein said authorization for performing said social health tracking feature is limited to a type of endpoint device.

6. The method of claim 4, wherein said authorization for performing said social health tracking feature is limited to a type of communication.

7. The method of claim 1, further comprising:
receiving one or more inputs from said customer as to how said social health status is determined.

8. The method of claim 7, wherein said one or more inputs from said customer pertains to one or more destinations.

9. The method of claim 1, wherein a service provider or said customer configures said period of time for tracking statistical changes for said one or more interactions.

10. The method of claim 3, wherein said social health status is presented as a numerical score, a graphical chart, or a categorical chart.

11. A computer-readable medium having stored thereon a plurality of instructions, the plurality of instructions including instructions which, when executed by a processor, cause the processor to perform the steps of a method for providing social health tracking, comprising:
receiving a request from a customer for a communication service having a social health tracking feature;
gathering data on one or more interactions for said customer;
updating a statistical model for said one or more interactions for said customer over a period of time; and
determining a social health status for said customer from said statistical model.

12. The computer-readable medium of claim 11, wherein said statistical model tracks one or more parameters comprising at least one of: a frequency of communication, a type of communication, or a duration of communication.

13. The computer-readable medium of claim 11, further comprising:
providing said social health status to said customer.

14. The computer-readable medium of claim 11, wherein an authorization for performing said social health tracking feature is received from said customer.

15. The computer-readable medium of claim 14, wherein said authorization for performing said social health tracking feature is limited to a type of endpoint device.

16. The computer-readable medium of claim 14, wherein said authorization for performing said social health tracking feature is limited to a type of communication.

17. The computer-readable medium of claim 11, further comprising:
receiving one or more inputs from said customer as to how said social health status is determined.

18. The computer-readable medium of claim 17, wherein said one or more inputs from said customer pertains to one or more destinations.

19. The computer-readable medium of claim 11, wherein a service provider or said customer configures said period of time for tracking statistical changes for said one or more interactions.

20. An apparatus for providing social health tracking, comprising:
means for receiving a request from a customer for a communication service having a social health tracking feature;
means for gathering data on one or more interactions for said customer;
means for updating a statistical model for said one or more interactions for said customer over a period of time; and
means for determining a social health status for said customer from said statistical model.
